(19) United States
(12) Patent Application Publication
(10) Pub. No.: US 2024/0155383 A1
(43) Pub. Date: May 9, 2024

(54) REINFORCEMENT LEARNING FOR SON PARAMETER OPTIMIZATION

(71) Applicant: Nokia Solutions and Networks Oy, Espoo (FI)

(72) Inventors: Antonio MASSARO, Massy (FR); Robert SEIDL, Munich (DE); Daniel WELLINGTON, Boulder, CO (US); Armen AGHASARYAN, Massy (FR)

(21) Appl. No.: 18/547,446

(22) PCT Filed: Mar. 16, 2021
(86) PCT No.: PCT/US2021/022483

§ 371 Date: Aug. 22, 2023

(51) Int. Cl. H04W 24/02

(52) U.S. Cl. CPC H04W 24/02; H04W 84/18

(57) ABSTRACT

A method includes receiving at least one network performance indicator of a communication network from at least one cell in the network; determining a reward for the at least one cell in the network based on the at least one network performance indicator; and determining whether to modify at least one self-organizing network parameter of the at least one cell in the network to change the at least one network performance indicator or an average value of the reward, based in part on the determined reward.

### TECHNICAL FIELD

The examples and non-limiting embodiments relate generally to communications and, more particularly, to reinforcement learning for SON parameter optimization.

### BACKGROUND

It is known to implement radio resource management (RRM) in a communication network.

### SUMMARY

In accordance with an aspect, a method includes receiving at least one network performance indicator of a communication network from at least one cell in the network; determining a reward for the at least one cell in the network based on the at least one network performance indicator; and determining whether to modify at least one self-organizing network parameter of the at least one cell in the network to change the at least one network performance indicator or an average value of the reward, based in part on the determined reward.

In accordance with an aspect, an apparatus includes at least one processor; and at least one non-transitory memory including computer program code; wherein the at least one memory and the computer program code are configured to, with the at least one processor, cause the apparatus at least to: receive at least one network performance indicator of a communication network from at least one cell in the network; determine a reward for the at least one cell in the network based on the at least one network performance indicator; and determine whether to modify at least one self-organizing network parameter of the at least one cell in the network to change the at least one network performance indicator or an average value of the reward, based in part on the determined reward.

In accordance with an aspect, an apparatus includes means for receiving at least one network performance indicator of a communication network from at least one cell in the network; means for determining a reward for the at least one cell in the network based on the at least one network performance indicator; and means for determining whether to modify at least one self-organizing network parameter of the at least one cell in the network to change the at least one network performance indicator or an average value of the reward, based in part on the determined reward.

In accordance with an aspect, a non-transitory program storage device readable by a machine, tangibly embodying a program of instructions executable by the machine for performing operations is provided, the operations comprising: receiving at least one network performance indicator of a communication network from at least one cell in the network; determining a reward for the at least one cell in the network based on the at least one network performance indicator; and determining whether to modify at least one self-organizing network parameter of the at least one cell in the network to change the at least one network performance indicator or an average value of the reward, based in part on the determined reward.

### BRIEF DESCRIPTION OF THE DRAWINGS

The foregoing aspects and other features are explained in the following description, taken in connection with the accompanying drawings.

FIG. 1 is a block diagram of one possible and non-limiting system in which the example embodiments may be practiced.

FIG. 2 illustrates basic tilt based load balancing with reinforcement learning.

FIG. 3 is a plot of average PRB utilization.

FIG. 4 is a schematic of embodiment 1 relating to domain directed exploration.

FIG. 5 is a schematic of embodiment 2 related to distributed tabular Q-learning with directed search.

FIG. 6 is a schematic of embodiment 3 related to distributed deep Q-learning with directed search.

FIG. 7 shows an example integration of an off-line simulator with a RL agent for initialization of the Q tables.

FIG. 8 is an apparatus configured to implement reinforcement learning for SON parameter optimization, based on the examples described herein.

FIG. 9 is a method to implement reinforcement learning for SON parameter optimization, based on the examples described herein.

### DETAILED DESCRIPTION OF EXAMPLE EMBODIMENTS

The following acronyms and abbreviations that may be found in the specification and/or the drawing figures are defined as follows:
4G fourth generation
5G fifth generation
5GC 5G core network
AMF access and mobility management function
ASIC application-specific integrated circuit
CIO cell individual offset
CU central unit or centralized unit
DDE domain directed exploration
DSP digital signal processor
DU distributed unit
eNB evolved Node B (e.g., an LTE base station)
EN-DC E-UTRA-NR dual connectivity
en-gNB node providing NR user plane and control plane
protocol terminations towards the UE, and acting as a secondary node in EN-DC
E-UTRA evolved universal terrestrial radio access, i.e., the LTE radio access technology
F1 control interface between the CU and the DU
FPGA field-programmable gate array
gNB base station for 5G/NR, i.e., a node providing NR user plane and control plane protocol terminations towards the UE, and connected via the NG interface to the 5GC
I/F interface
I/O input/output
KPI or kpi key performance indicator
LMF location management function
LTE long term evolution (4G)
MAC medium access control
max maximum
MIMO multiple input multiple output
MME mobility management entity
MN master node
NCE network control element
ng or NG new generation
ng-eNB new generation eNB
NG-RAN new generation radio access network
NR new radio (5G)
N/W network
O-RAN or ORAN open radio access network
PDA personal digital assistant
PDCP packet data convergence protocol
PHY physical layer
PRB or prb physical resource block
Q or q function that an algorithm computes with the maximum expected rewards for an action taken in a given state
RAN radio access network
Rew reward
RL reinforcement learning
RLC radio link control
RRC radio resource control (protocol)
RRH remote radio head
RRM radio resource management
RU radio unit
Rx receiver or reception
SGW serving gateway
SON self-organizing/optimizing network
TOT total
TPRB threshold PRB
TPU throughput per user
TRP transmission and reception point
Tx transmitter or transmission
UE user equipment (e.g., a wireless, typically mobile device)
UPF user plane function
X2 network interface between RAN nodes and between
RAN and the core network
Xn network interface between NG-RAN nodes

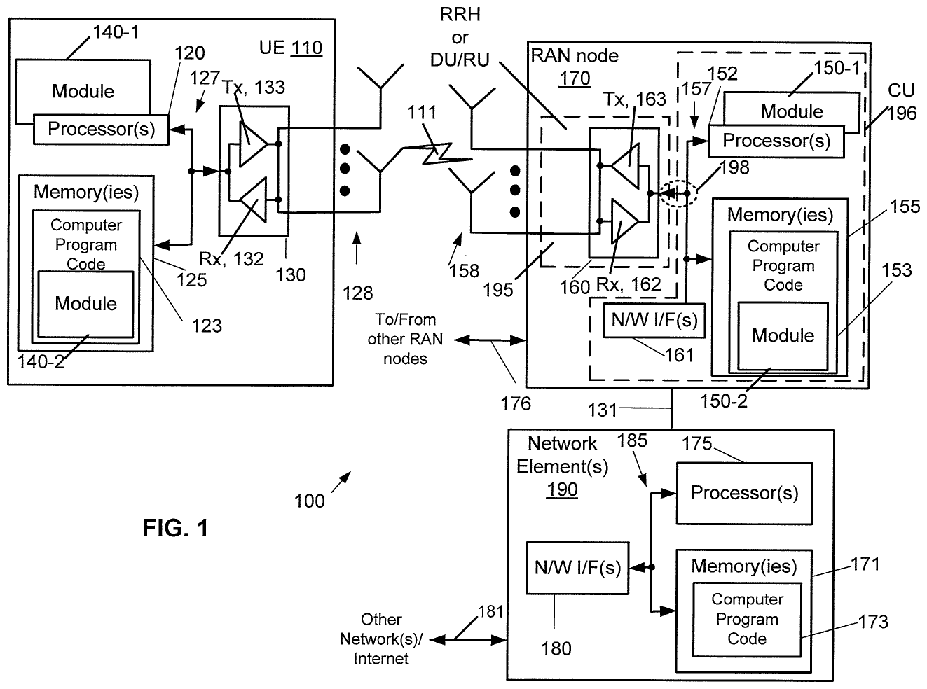

Turning to FIG. 1, this figure shows a block diagram of one possible and non-limiting example in which the examples may be practiced. A user equipment (UE) 110, radio access network (RAN) node 170, and network element(s) 190 are illustrated. In the example of FIG. 1, the user equipment (UE) 110 is in wireless communication with a wireless network 100. A UE is a wireless device that can access the wireless network 100. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more memories 125 include computer program code 123. The UE 110 includes a module 140, comprising one of or both parts 140-1 and/or 140-2, which may be implemented in a number of ways. The module 140 may be implemented in hardware as module 140-1, such as being implemented as part of the one or more processors 120. The module 140-1 may be implemented also as an integrated circuit or through other hardware such as a programmable gate array. In another example, the module 140 may be implemented as module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with RAN node 170 via a wireless link 111.

The RAN node 170 in this example is a base station that provides access by wireless devices such as the UE 110 to the wireless network 100. The RAN node 170 may be, for example, a base station for 5G, also called New Radio (NR). In 5G, the RAN node 170 may be a NG-RAN node, which is defined as either a gNB or an ng-eNB. A gNB is a node providing NR user plane and control plane protocol terminations towards the UE, and connected via the NG interface (such as connection 131) to a 5GC (such as, for example, the network element(s) 190). The ng-eNB is a node providing E-UTRA user plane and control plane protocol terminations towards the UE, and connected via the NG interface (such as connection 131) to the 5GC. The NG-RAN node may include multiple gNBs, which may also include a central unit (CU) (gNB-CU) 196 and distributed unit(s) (DUs) (gNB-DUs), of which DU 195 is shown. Note that the DU 195 may include or be coupled to and control a radio unit (RU). The gNB-CU 196 is a logical node hosting radio resource control (RRC), SDAP and PDCP protocols of the gNB or RRC and PDCP protocols of the en-gNB that control the operation of one or more gNB-DUs. The gNB-CU 196 terminates the F1 interface connected with the gNB-DU 195. The F1 interface is illustrated as reference 198, although reference 198 also illustrates a link between remote elements of the RAN node 170 and centralized elements of the RAN node 170, such as between the gNB-CU 196 and the gNB-DU 195. The gNB-DU 195 is a logical node hosting RLC, MAC and PHY layers of the gNB or en-gNB, and its operation is partly controlled by gNB-CU 196. One gNB-CU 196 supports one or multiple cells. One cell is supported by only one gNB-DU 195. The gNB-DU 195 terminates the Fl interface 198 connected with the gNB-CU 196. Note that the DU 195 is considered to include the transceiver 160, e.g., as part of a RU, but some examples of this may have the transceiver 160 as part of a separate RU, e.g., under control of and connected to the DU 195. The RAN node 170 may also be an eNB (evolved NodeB) base station, for LTE (long term evolution), or any other suitable base station or node.

The RAN node 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The CU 196 may include the processor(s) 152, memory(ies) 155, and network interfaces 161. Note that the DU 195 may also contain its own memory/memories and processor(s), and/or other hardware, but these are not shown.

The RAN node 170 includes a module 150, comprising one of or both parts 150-1 and/or 150-2, which may be implemented in a number of ways. The module 150 may be implemented in hardware as module 150-1, such as being implemented as part of the one or more processors 152. The module 150-1 may be implemented also as an integrated circuit or through other hardware such as a programmable gate array. In another example, the module 150 may be implemented as module 150-2, which is implemented as computer program code 153 and is executed by the one or more processors 152. For instance, the one or more memories 155 and the computer program code 153 are configured to, with the one or more processors 152, cause the RAN node 170 to perform one or more of the operations as described herein. Note that the functionality of the module 150 may be distributed, such as being distributed between the DU 195 and the CU 196, or be implemented solely in the DU 195.

The one or more network interfaces 161 communicate over a network such as via the links 176 and 131. Two or more gNBs 170 may communicate using, e.g., link 176. The link 176 may be wired or wireless or both and may implement, for example, an Xn interface for 5G, an X2 interface for LTE, or other suitable interface for other standards.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195 for LTE or a distributed unit (DU) 195 for gNB implementation for 5G, with the other elements of the RAN node 170 possibly being physically in a different location from the RRH/DU 195, and the one or more buses 157 could be implemented in part as, for example, fiber optic cable or other suitable network connection to connect the other elements (e.g., a central unit (CU), gNB-CU 196) of the RAN node 170 to the RRH/DU 195. Reference 198 also indicates those suitable network link(s).

It is noted that the description herein indicates that “cells” perform functions, but it should be clear that equipment which forms the cell may perform the functions. The cell makes up part of a base station. That is, there can be multiple cells per base station. For example, there could be three cells for a single carrier frequency and associated bandwidth, each cell covering one-third of a 360 degree area so that the single base station's coverage area covers an approximate oval or circle. Furthermore, each cell can correspond to a single carrier and a base station may use multiple carriers. So if there are three 120 degree cells per carrier and two carriers, then the base station has a total of 6 cells.

The wireless network 100 may include a network element or elements 190 that may include core network functionality, and which provides connectivity via a link or links 181 with a further network, such as a telephone network and/or a data communications network (e.g., the Internet). Such core network functionality for 5G may include location management functions (LMF(s)) and/or access and mobility management function(s) (AMF(S)) and/or user plane functions (UPF(s)) and/or session management function(s) (SMF(s)). Such core network functionality for LTE may include MME (Mobility Management Entity)/SGW (Serving Gateway) functionality. Such core network functionality may include SON (self-organizing/optimizing network) functionality. These are merely example functions that may be supported by the network element(s) 190, and note that both 5G and LTE functions might be supported. The RAN node 170 is coupled via a link 131 to the network element 190. The link 131 may be implemented as, e.g., an NG interface for 5G, or an S1 interface for LTE, or other suitable interface for other standards. The network element 190 includes one or more processors 175, one or more memories 171, and one or more network interfaces (N/W I/F(s)) 180, interconnected through one or more buses 185. The one or more memories 171 include computer program code 173.

The wireless network 100 may implement network virtualization, which is the process of combining hardware and software network resources and network functionality into .a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors 152 or 175 and memories 155 and 171, and also such virtualized entities create technical effects.

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, non-transitory memory, transitory memory, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, RAN node 170, network element(s) 190, and other functions as described herein.

In general, the various embodiments of the user equipment 110 can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, head mounted displays such as those that implement virtual/augmented/mixed reality, as well as portable units or terminals that incorporate combinations of such functions.

UE 110, RAN node 170, and/or network element(s) 190, (and associated memories, computer program code and modules) may be configured to implement (e.g. in part) the methods described herein, including reinforcement learning for SON parameter optimization. Thus, computer program code 123, module 140-1, module 140-2, and other elements/features shown in FIG. 1 of UE 110 may implement user equipment related aspects of the methods described herein. Similarly, computer program code 153, module 150-1, module 150-2, and other elements/features shown in FIG. 1 of RAN node 170 may implement gNB/TRP related aspects of the methods described herein. Computer program code 173 and other elements/features shown in FIG. 1 of network element(s) 190 may be configured to implement network element related aspects of the methods described herein.

Having thus introduced a suitable but non-limiting technical context for the practice of the example embodiments, the example embodiments are now described with greater specificity.

Radio network optimization is a very complex optimization problem. Given the high number of network parameters that can be adjusted, and the variety of KPIs that can be optimized, it translates into a highly combinatorial problem, whose solution is a challenging task. Moreover, the inherent stochasticity produced by random movements of user equipment makes the problem even harder to solve. Network optimization is usually performed by algorithms that are crafted by domain experts and use static, threshold-based triggers for evaluation and decision-making. Such thresholds need to be carefully gauged by domain experts. While these modules can be sophisticated and complex, they are not continually learning from their decisions in a cognitive sense. The examples described herein go beyond this paradigm, designing solutions based on cognitive methods that allow for autonomous and adaptive network optimization, without human intervention.

In particular, the examples described herein use reinforcement learning to make modules truly cognitive. RL has the advantage that it can learn from the large numbers of closed loop decisions. There are four major areas of practical concern that need to be addressed to develop a working reinforcement learning solution.
1. Q-Learning exploration is typically random. Random parameter changes conducted on live networks can create short term performance risks to the network and most definitely create perception issues with customers. Exploration cannot be performed randomly.
2. Time varying traffic. Radio networks are dynamic and one of the challenges for reinforcement learning to provide fast convergence is that the traffic is stochastic and differs for each cell. Traffic is further affected by closed loop changes, in the sense that software agents act on the network, modifying its parameters and hence influencing the traffic patterns. The solution needs to adaptively react to the current state of the network.
3. Low resolution KPI data and limited history. Typical SON networks have 15-minute KPI resolution and often no more than a week of past data history. This means that the amount of data from which the algorithms can learn is limited and needs to be used as efficiently as possible to grant reasonably fast convergence.
4. Scaling. One of the challenges with implementing machine learning based solutions for network optimization, especially deep learning solutions, is that they do not scale easily with the number of cells and may require excessive memory and processing power.

Many AI based approaches suffer from the combinatorial explosion problem inherent in tuning large networks and can lead to lengthy convergence times. The typical SON module takes as inputs various RAN KPIs and feeds this information into pre-defined algorithms for each cell or cluster of cells. These algorithms are domain expert crafted algorithms that use threshold-based triggers for evaluation and decision-making. When instructed to take action, the module directs managed object changes to the radio access network (RAN) via the network management system and SON platform. Through a feedback loop, that is updated every KPI interval, decisions are re-evaluated and repeated. This allows some incremental degree of optimization to be achieved. While many of these modules are quite sophisticated and complex, none are continually learning from their decisions in a cognitive sense.

The solutions described herein using reinforcement learning provide the resources for making network management truly cognitive. RL has the advantage that it can learn from the large numbers of closed loop decisions.

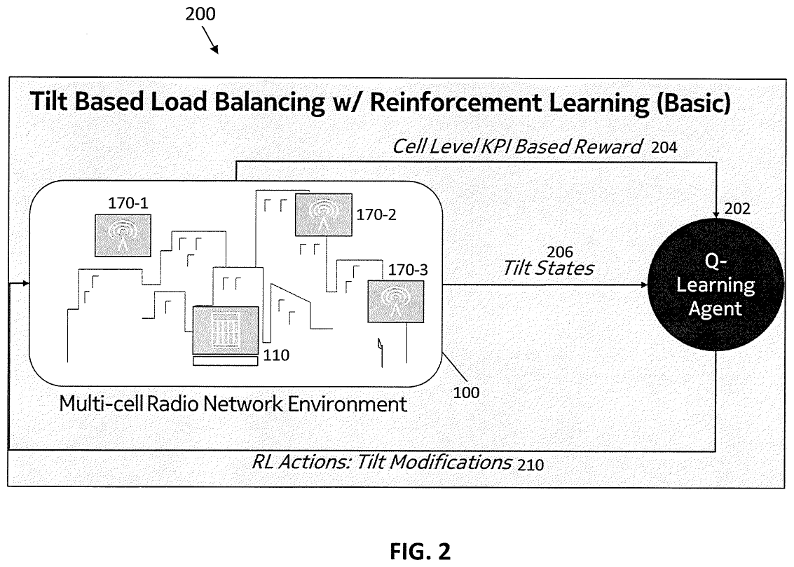

With reference to FIG. 2, described herein is a network optimization system 200 based on reinforcement learning. The objective of such system is to modify the antenna electric tilts of all cells in a radio network (e.g. the electric antenna tilt of a RAN node 170, such as a gNB or an eNB), so as to optimize an objective function that is calculated as a weighted average of network download throughput and network physical resource block utilization. The RL agent 202 is connected to the radio network 100. It reads in real time specific network KPIs. Such KPIs are fed into a function that calculates the current network state. For example, as shown in FIG. 2 a cell level KPI based reward 204 is provided to the Q-learning agent 202. Based on the current state (such as tilt states 206), the RL agent 202 prescribes an action (i.e. one or more RL actions 210) to the radio network 100. In this context, such action 210 is a choice of the electric antenna tilt for each cell in the network 100 (e.g. the electric antenna tilt of a RAN node 170, such as a gNB or an eNB). By evaluating the effect of such choice on the network KPIs that need to be optimized, the RL agent 202 learns to choose the actions that maximize the objective function's values.

As further shown in FIG. 2, the network 100 comprises a number of base stations (e.g. gNBs) 170, including 170-1, 170-2, and 170-3 interspersed through and between various building structures, as well as a terminal 110. Each of the base stations 170-1, 170-2, and 170-3 provide access for the terminal 110 to the network 100 via one or more cells.

Thus, the examples described herein involve the definition of the states, the definition of the reward, the definition of the actions, and the action's space search strategy.

In all the following embodiments, the strategy according to which the learning agent chooses its actions (i.e. the cells' electric antenna tilts, or the electric antenna tilts of RAN node 170, such as a gNB or eNB) is performed according to the domain directed exploration method.

### Embodiment 1: Domain Directed Exploration

In this embodiment each cell estimates, from its experience, the reward that can be achieved, on average, for each possible level of prb utilization. At the same time, each cell tries to drive its prb utilization towards the value that yields the highest reward. It does this by increasing the electric antenna tilt if the prb needs to be decreased and decreasing the antenna electric tilt in the opposite case (i.e. if the prb needs to be increased).

### Embodiment 2: Distributed Tabular Q-Learning With Directed Search

In this embodiment each cell maintains a Q-table (e.g. a RAN node 170 maintains a Q-table) and aims at optimizing a reward that is calculated at the single cell level. The search strategy is not random. Rather, domain directed exploration is used to explore the actions' space.

### Embodiment 3: Distributed Deep Q-Learning With Directed Search

In this embodiment, a deep neural network is used to approximate the Q-table. It is distributed in the sense that the deep neural network predicts, for each state-action couple at the single cell-level, the reward achieved at such cell. Exploration of the actions' space is performed using the domain directed exploration algorithm.

### Embodiment 4: Any of the Previous Embodiments, With Collaborative Reward

This embodiment is an extension of all the previous embodiments and prescribes a method to compute the reward at the single cell level, that takes into account also the impact of the action of a cell on the neighboring cells.

### Embodiment 5: Any of the Previous Embodiments, With Off-Line Initialization

This embodiment is an extension of all the previous ones and prescribes a method for initializing the Q tables during an off-line training phase with policies identified by an off-line simulation of an approximate model of the system.

Compared to other approaches, the methods described herein have the following advantages: i) the optimal antenna tilt strategy is learned on-line, ii) the optimal antenna tilt strategy adapts to the current network state dynamically, iii) the convergence time is short, and iv) the solution is scalable to networks of thousands of cells.

The objective of the solutions is to maximize the network download throughput while minimizing the network physical block utilization, by adapting the antennas' electric tilt of all cells, or at least one cell. Before describing each embodiment, some notation is introduced, that applies to all of them. The time-granularity at which the solution prescribes an action to the network is 15 minutes. During such time-span, the RL agent collects instantaneous KPI values from the network. At the end of such time-span, the RL agent calculates the average of such instantaneous KPI values. Such averaged KPIs are the inputs to the state and reward calculation. Next, averaged KPIs are normalized, using the normal cumulative function. Each KPI is normalized using a specifically tailored normal cumulative function. The mean and standard deviation that characterize the cumulative function applied to the n-th KPI is the sample mean and standard deviation of a set of readings of such KPI, recorded on all cells and calculated on a sufficiently long-time span, where a benchmark static policy is put in place in the network. As a result, each KPI is mapped to a normalized KPI, ranging between 0 and 1.

The following notation is defined that embodies those concepts.

### Per-Cell KPIs

The average per user download throughput registered by cell cat a sampling time-point t is denoted as TPU(c, t). The physical resource block utilization registered at cell c at a sampling time-point t is denoted as PRB(c, t). The number of active users connected to cell c at a sampling point t is denoted as USERS(c, t). The average values of such KPIs across a time-window T, ending at t, is denoted as

$$\overline{TPU} ( c , t ) = \frac{1}{T} {\sum }_{τ = t - T}^{t} TPU ( c , τ )$$

$$\overline{PRB} ( c , t ) = \frac{1}{T} {\sum }_{τ = t - T}^{t} PRB ( c , τ )$$

$$\overline{USERS} ( c , t ) = \frac{1}{T} {\sum }_{τ = t - T}^{t} USERS ( c , τ )$$

Next, the threshold PRB at a cell, averaged over a time window T is defined as follows

T̅P̅R̅B̅(c, t)=max(0, P̅R̅B̅(c, t)−0.7)+max(0, 0.3−P̅R̅B̅(c, t))

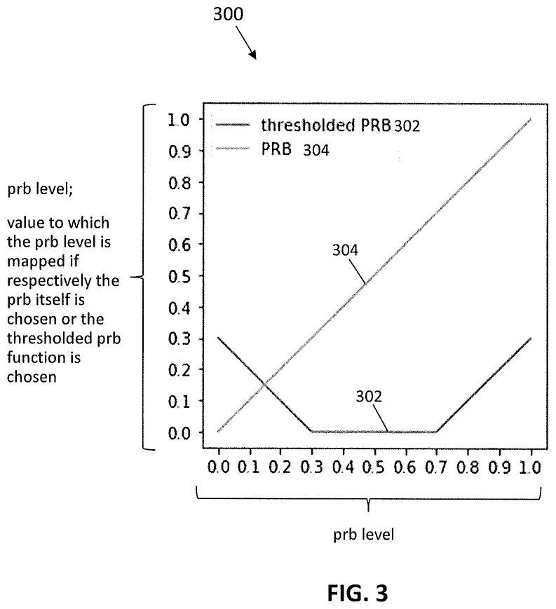

This choice is operated because the goal is to drive the system towards an average PRB utilization in the range 30%-70%. This becomes apparent in the plot 300 shown in FIG. 3. In FIG. 3, plot 302 is a plot of thresholded PRB and plot 304 is a plot of PRB. In FIG. 3, on the x axis (horizontal axis) is the prb level (it is a number that, by definition, ranges between 0 and 1). On the y axis (vertical axis) is the prb level, or the value to which the prb level is mapped if respectively the prb itself is chosen (and therefore, trivially, the identity function corresponds to the line 304) or the thresholded prb function (line 302).

The idea of the thresholded prb is to reward more the states where the prb belongs to the range between 30% and 70%. Since the thresholded prb composes the reward function, this choice naturally leads the agent to drive the system towards a prb utilization in the 30%-70% range. The difference between the thresholded prb (e.g. item 302) and the prb (e.g. item 304) is explained in the formula for the thresholded prb, namely

T̅P̅R̅B̅(c, t)=max(0, P̅R̅B̅(c, t)−0.7)+max(0, 0.3−P̅R̅B̅(c, t)).

The range is configurable, that is the values 0.7 and 0.3 in the above formula are configurable (they can be changed according to a user specification).

Finally, the normalized per-cell KPI(s) is defined as follows. Let Φ(⋅, μ, σ) be the cumulative distribution function of the normal distribution with mean equal to μ and standard deviation equal to σ.

T̅P̅U̅_̅N̅(c, t)=Φ(T̅P̅U̅(c, t), μ_{T̅P̅U̅}, σ_{T̅P̅U̅})

where μ_{T̅P̅U̅} and σ_{T̅P̅U̅} are respectively the sample mean and the sample standard deviation of all measurements {T̅P̅U̅(c, t):c=1, . . . , C; t=0, . . . , T}, recorded in a simulation round where all the electric tilts have been set to a static value (in an example case such value is 4 degrees).

Likewise, define

P̅R̅B̅_̅N̅(c, t)=Φ(P̅R̅B̅(c, t), μ_{P̅R̅B̅}, σ_{P̅R̅B̅}),

T̅P̅R̅B̅_̅N̅(c, t)=Φ(T̅P̅R̅B̅(c, t), μ_{T̅P̅R̅B̅}, σ_{T̅P̅R̅B̅}), and

U̅S̅E̅R̅S̅_̅N̅(c, t)=Φ(U̅S̅E̅R̅S̅(c, t), μ_{U̅S̅E̅R̅S̅}, σ_{U̅S̅E̅R̅S̅}).

### Per-Cluster KPIs

When dealing with cluster-level KPIs (where the cluster is composed of C cells), they are defined as an aggregated value, across all the clusters, as follows:

$$\overline{TPRB} ( t ) = \frac{1}{C} {\sum }_{c = 1}^{C} \overline{TPRB} ( c , t )$$

$$\overline{TPU} ( t ) = {\sum }_{c = 1}^{C} \overline{TPU} ( c , t ) \frac{\overline{USERS} ( c , t )}{{\sum }_{c} \overline{USERS} ( c , t )}$$

$$\overline{USERS} ( t ) = {\sum }_{c = 1}^{C} \overline{USERS} ( c , t ) .$$

And they are normalized in the usual way for the first two:

T̅P̅U̅_̅N̅(t)=Φ(T̅P̅U̅(t), μ_{T̅P̅U̅}, σ_{T̅P̅U̅})

T̅P̅R̅B̅_̅N̅(t)=Φ(T̅R̅B̅(t), μ_{T̅R̅B̅}, σ_{T̅R̅B̅}).

And as follows for the number of users

$$\overline{USERS\_ N} ( t ) = \frac{{max}_{τ} \{ \overline{USERS} ( τ ) \} - \overline{USERS} ( t )}{{max}_{τ} \{ \overline{USERS} ( τ ) \}} .$$

### Reward

The goal is to optimize the network throughput, together with the physical resource block (prb) utilization. Specifically, the goal is to increase the network throughput, keeping the prb utilization as low as possible. Consequently, the reward is defined in a consistent fashion: the reward is a function of the throughput and the prb utilization. The cell reward is defined as follows:

Rew(c, t)=0.5+0.5·T̅P̅U̅_̅N̅(c, t)−0.5 ·T̅P̅R̅B̅_̅N̅(c, t).

The cluster reward is defined as follows:

Rew(t)=0.5+0.5·T̅P̅U̅_̅N̅(t)−0.5 ·T̅P̅R̅B̅_̅N̅(t).

### States

In the definition of the state of the network, a goal is to embody the necessary information needed to take an optimization step. Each embodiment uses a different choice of the KPIs that define the state, hence they are specified when each embodiment is discussed.

### Actions

The actions leveraged for the KPIs optimization are the antennas' electric tilts. It is a parameter that can be gauged at each cell. It assumes discrete integer values. The action is expressed in down-tilt degrees, meaning that, the higher the action value, the more down-tilted the antenna is.

### Embodiment 1: Domain Directed Exploration

The idea with domain directed exploration is that of looking at the current prb utilization of each cell, and potentially modifying the antenna tilt of the cell, with the objective of pushing the prb utilization in the direction of the value that, historically, has yielded the best reward.

This embodiment exploits the fact that it is known that down-tilting decreases the prb utilization, whereas up-tilting increases the prb utilization, therefore it is known in which direction the antenna should be moved in order to achieve the desired prb and it is not learned from data.

This is reasonable as up-tilting results in a bigger number of users being covered by the cell, hence the prb utilization increases accordingly.

Estimating, for each prb level, the average of the reward experienced at such prb level, allows the search agent to understand which are the prb levels that are associated to the highest average reward value. Once these quantities are known, the search agent stirs the tilt of each cell as to move the current prb utilization towards the optimal one.

This is made clear in the following pseudo-code. It is assumed that the prb utilization is quantized between 0 and 1, with discrete step equal to 0.1.

```
  1. initialize tables N, R, Q ∈ R^{C×10} at 0
  2. for t = 1, . . . , T
  3. for c = 1, 2, . . . , C
  4. prb_current(c) ← P̅R̅B̅_̅N̅(c, t)
  5. prb(c) ← argmax_{prb}{Q[c, 0.1], . . . , Q[c, 1]}
  6. If prb(c) > prb_current(c), then A[c] ← A[c] − 1
  7. If prb(c) < prb_current(c), then A[c] ← A[c] + 1
  8. N[c, prb_current(c)] ← N[c, prb_current(c)] + 1
  9. R[c, prb_current(c)] ← R[c, prb_current(c)] + Rew(c, t)
$10. Q [ c , prb\_current ( c ) ] ← \frac{R [ c , prb\_current ( c ) ]}{N [ c , prb\_current ( c ) ]}$
```

In the above pseudo-code, A[ ] is the action object/vector (e.g. tilt action), R[ ] is the cumulated (i.e. summed) reward object/vector, Q[ ] is the averaged reward object/vector, and Rew is the reward value. The N[ ] object registers the number of times a given event has happened during the training phase. This is needed to compute the average values of the rewards corresponding to the respective event. Specifically, N[c, prb_current(c)] is increased by 1 every time cell c experiences a prb equal to prb_current.

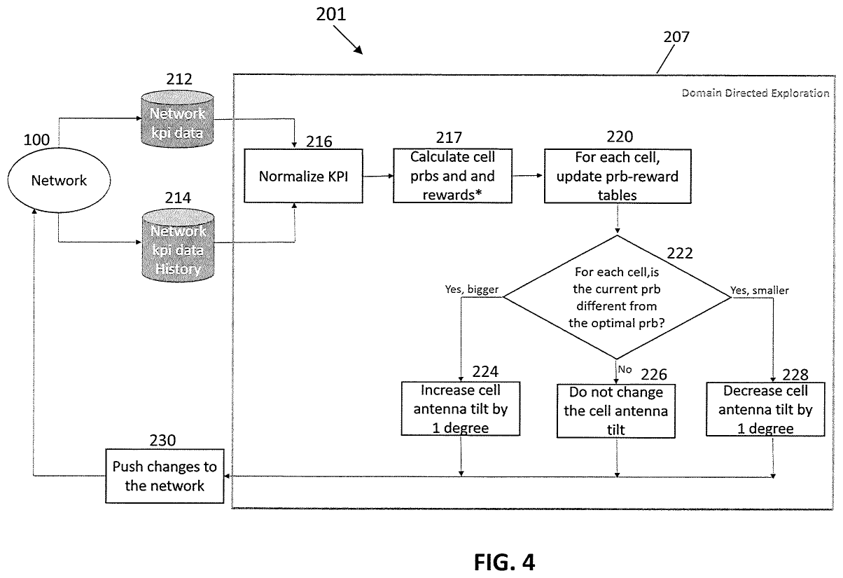

FIG. 4 is a schematic 201 of embodiment 1 relating to domain directed exploration 207. The network 100 provides network KPI data to database 212, and provides network KPI data history to database 214. At 216, the KPI data is normalized, namely the KPI data from network KPI data database 212 and the network KPI data history database 214. At 217, the cell PRBs and rewards are calculated. At 220, for each cell, the PRB-reward tables are updated. As described herein, a prb-reward table registers, for each prb level experienced by the cell, what is, on average, the reward for that cell. At 222, a determination is made for each cell, namely whether the current PRB is different from the optimal PRB. If the current PRB is bigger than the optimal PRB, then the domain directed exploration 207 transitions to 224. At 224, the cell antenna tilt is increased by 1 degree. If the current PRB is not different from the optimal PRB, then the DDE 207 transitions to 226. At 226, the cell antenna tilt is not changed. If the current PRB is smaller than the optimal PRB, then the DDE 207 transitions to 228. At 228, the cell antenna tilt is decreased by 1 degree. Following 224, 226, and 228, the method 201 transitions to 230, where the changes (e.g. to antenna tilt) if any are pushed to the network 100. Embodiment 4 for DDE has the same structure as the schematic 201 shown in FIG. 4, where the reward calculation at 217 (*) for embodiment 4 (collaborative reward) is given by the reward calculation as specified in the description of embodiment 4.

### Embodiment 2: Distributed Tabular Q-Learning With Directed Search

This algorithm implements a simplified form of tabular Q-learning, where the Q-values approximate the expected value of the reward at the next time step, for every state-action pair.

In embodiment 2, each cell maintains its own Q-table. The state is the normalized number of active users in the cell. Such variable is quantized into 10 possible discrete values, namely 0.1, 0.2, 0.3, 0.4, 0.5, 0.6, 0.7, 0.8, 0.9, 1.0. The actions are all possible electric antenna tilts available to the cell, namely 4, 5, 6, . . . , 14.

In this case, each cell stores a Q-table whose dimensions are 10×10. The pseudocode to implement embodiment 2 is as follows.

```
  1. initialize tables N, R, Q ∈ R^{C×10×10} at 0
  2. for T = 1, . . . , T
  3. s_{t,c} = U̅S̅E̅R̅S̅_̅N̅(c,t), quantized
  4. X ← Uniform random extraction
  5. If X < ε(t):
  6. for c = 1, 2, . . . , C:
    7. A[c] ← apply DomainDirectedSearch
  8. Else:
  9. for c = 1, 2, . . . , C:
    10. A[c] ← argmax_A{Q[c, s_{t,c}, A₁], . . . , Q[c, s_{t,c}, Aₙ] }
11. Perform at each cell c action A[c] and observe Rew(c, t + 1)
11. for c = 1, 2, . . . C
12. N[c, s_{t,c}, A] ← N[c, s_{t,c}, A] + 1
13. R[c, s_{t,c}, A] ← R[c, s_{t,c}, A] + Rew(c, t + 1)
$14. Q [ c , {s}_{t , c} , A ] ← \frac{R [ c , {s}_{t , c} , A ]}{N [ c , {s}_{t , c} , A ]}$
```

In the above pseudo-code, A[ ] is the action object/vector (e.g. tilt action), R[ ] is the cumulated (i.e. summed) reward object/vector, Q[ ] is the averaged reward object/vector, and Rew is the reward value. The N[ ] object registers the number of times a given event has happened during the training phase. This is needed to compute the average values of the rewards corresponding to the respective event. Specifically, N[c, s_{t,c}, A] is increased by 1 every time cell c is at state s_{t,c} and takes action A.

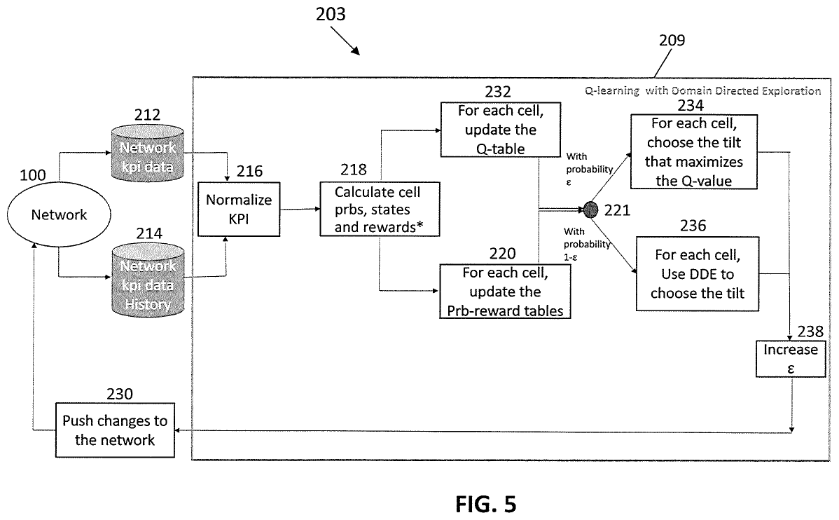

FIG. 5 is a schematic 203 of embodiment 2 relating to Q-learning with domain directed exploration 209. The network 100 provides network KPI data to database 212, and provides network KPI data history to database 214. At 216, the KPI data is normalized, namely the KPI data from network KPI data database 212 and the network KPI data history database 214. At 218, the cell PRBs, states, and rewards are calculated. At 220, for each cell, the PRB-reward tables are updated. At 232, for each cell, the Q-table is updated. A prb-reward table registers, for each prb level experienced by the cell, what is, on average, the reward for that cell. On the other hand, the Q-table registers, for each possible state of the cell and for each possible action (i.e. tilt applied during training), the reward, on average, experienced by the cell.

Random number generator 221 then generates an item, such that with probability ε the method 209 transitions to 234, and with probability 1−ε the method 209 transitions to 236. At 234, for each cell, the tilt is chosen such that the Q-value is maximized (where the Q-value is the average reward). At 236, DDE is used to choose the tilt. At 238, following 234 and 236, the probability ε is increased such that the Q-table and Q-value are used more frequently to choose the tilt in subsequent iterations. Following 234, 236, and 238, the method 203 transitions to 230, where the changes (e.g. to antenna tilt) if any are pushed to the network 100. Embodiment 4 for Q-learning with DDE has the same structure as the schematic 203 shown in FIG. 5, where the reward calculation at 218 (*) for embodiment 4 (collaborative reward) is given by the reward calculation as specified in the description of embodiment 4.

### Embodiment 3: Distributed Deep Q-Learning With Directed Search

Let N KPI be the number of KPIs used to describe the state of each cell. Let Ncells be the total number of cells. The input to the neural network is a vector in [0, 1]^{N}^{_{Cells}}^{×N}^{_{KPI}}. Let Nₜᵢₗₜₛ be the number of possible antenna tilts that can be applied at each cell. The output of the neural network is a vector in [0, 1]^{N}^{_{Cells}}^{×N}^{ₜᵢₗₜₛ}.

The idea of embodiment 3 is that each entry of the output represents the expected reward at a given cell, for a given cell's antenna tilt. Once the neural network is trained, it should provide, for a state of the system encoded in the input vector, the reward at each cell for each possible choice of its tilt. Hence, to choose the best tilt configuration, the method has to pick, for each cell, the action whose entry maximizes the predicted reward.

### Training

The training is performed in batches: at each training round, for a set of inputs, a set of target outputs are collected, and then the network is trained by usual gradient descent. Such target outputs are calculated as follows (exploration is done just like in embodiment 2, where domain directed exploration is used).

Let X be an input vector representing the state of the system. Let A be a vector encoding the action taken. The action is encoded as follows: A is a vector in {0, 1}^{N}^{_{Cells}}^{×N}^{ₜᵢₗₜₛ}. If cell I applies the j-th tilt, the i·Nₜᵢₗₜₛ+j-th entry is set to 1, otherwise to 0.

Let R be the reward observed at the following time-step. R is a vector whose dimension is equal to N_{Cells}. It is calculated at single cell level, and each entry is different.

Let Y=N(X) be the output vector of the neural network when applied to X. Set Y̅[i]=R[i] if A[i]=1, else Y̅[i] =Y[i]. That is, modify the entries of Y that correspond to the action taken at each cell, by overwriting them with the reward calculated at that cell. Such vector Y̅ is the target vector that is used to train the neural network on the input X.

By training the neural network, it approximates the expected value of the reward at the next time-step, for each cell and each action.

### States and Reward Calculation Choices

There are several choices for the state calculations, as follows.
For each cell: T̅P̅U̅_̅N̅(c, t), T̅P̅R̅B̅_̅N̅(c, t)
For each cell: T̅P̅U̅_̅N̅(c, t), P̅R̅B̅_̅N̅(c, t)
For each cell: U̅S̅E̅R̅S̅_̅N̅(c, t)

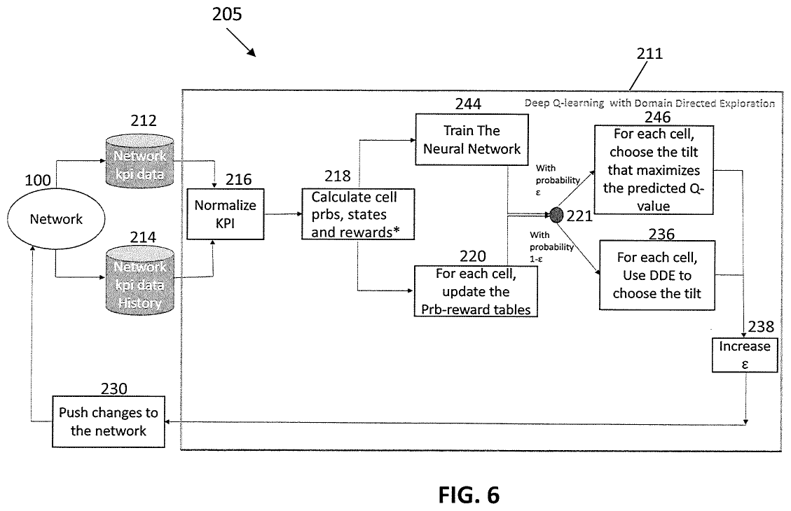

FIG. 6 is a schematic 205 of embodiment 3 relating to deep Q-learning with domain directed exploration 211. The network 100 provides network KPI data to database 212, and, provides network KPI data history to database 214. At 216, the KPI data is normalized, namely the KPI data from network KPI data database 212 and the network KPI data history database 214. At 218, the cell PRBs, states, and rewards are calculated. At 220, for each cell, the PRB-reward tables are updated. A prb-reward table registers, for each prb level experienced by the cell, what is, on average, the reward for that cell. At 244 the neural network is trained. Random number generator 221 then generates an item, such that with probability ε the method 211 transitions to 246, and with probability 1-2 the method transitions to 236. At 246, for each cell, the tilt is chosen such that the predicted Q-value is maximized (where the Q-value is the average reward). At 236, DDE is used to choose the tilt. At 238, following 246 and 236, the probability ε is increased such that the neural network (e.g. to learn the Q-table) and Q-value are used more frequently to choose the tilt in subsequent iterations. Following 246, 236, and 238, the method 205 transitions to 230, where the changes are pushed to the network 100. Embodiment 4 for deep Q-learning with DDE has the same structure as the schematic 205 shown in FIG. 6, where the reward calculation at 218 (*) for embodiment 4 (collaborative reward) is given by the reward calculation as specified in the description of embodiment 4.

### Embodiment 4: Collaborative Reward

In all previous embodiments, the reward to be optimized is always calculated at the single cell level, and every cell acts, in .a way, independently from the others. On the other hand, the electric antenna tilt of one cell influences directly the KPIs of the neighboring cells, because some users switch cells. In order to take this into account the effect of a cell's action on the neighboring cell KPI, the idea of collaborative reward is introduced, that is, a weighted average of the rewards as calculated by a cell and the neighboring cells, as follows:

$$coll \_ rew ( cell ) = rew ( cell ) + α {\sum }_{c ∈ neighbours ( cell )} rew ( c )$$

where ≢ is a constant, smaller than 1.

### Embodiment 5: Off-Line Initialization

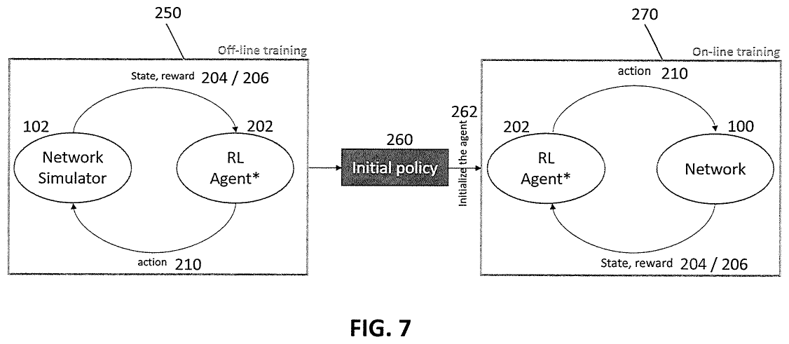

In all the previous embodiments, the Q tables were initialized with zeros. In embodiment 5, with reference to FIG. 7 comprising off-line training 250 and on-line training 270, the solution takes the benefit of the existing network simulation tools to put in place an integration of an off-line simulator 102 with a RL agent 202, allowing to provide a good initialization of the Q tables resulting in shortening of the on-line learning curve.

This method is composed of the following steps.
1. Build a representative simulator 102 (digital twin) of the network 100 which gives a reasonable approximation of the basic parameters of the real network 100 in terms of its scale, physical topology, geographical map, KPIs, etc.
2. Connect the simulator 102 within a closed loop for off-line training 250 (the closed loop comprising state feedback 204, reward feedback 206 and action feedback 210) with an RL agent 202 and converge towards a Q table following one of the previously described methods. Alternatively, any other state of the art RL method can be applied while keeping the reward definition identical with the real network settings.
3. Apply the on-line learning 270 on the real system 100 by initializing the default policies (Q table) of the RL agent 202 as learned in the simulation during off-line training 250 (the initializing being via initial policy 260 and initializing the agent 262), following one of the methods described previously. In this case, there is no one to one mapping of the cell identifiers from the simulator 102 to the real network 100. The simulator Q table can be transformed through an approximate mapping of cells according their common geographical location coordinates.

Note that a high degree of accuracy is not needed in the digital twin 102. A quite rough configuration is sufficient to provide a starting point for the on-line RL 270; the goodness of that starting point should be measured only against a random or a constant tilt configuration for all cells, while its impact is in shortening the learning curve.

The examples described herein may be used in the Eden-NET SON platform for closed loop optimization modules, and potentially in 5G mobile networks or as a machine learning solution in O-RAN. Further, the solution described herein may be implemented in a SON, MN or ORAN product, improving upon generic reinforcement learning solutions that have the limitations identified herein.

In addition, the examples described herein apply to other SON parameters that can affect load balancing beyond just electrical tilts. These parameters include tilts, electrical tilts, MIMO antennas and mobility parameters (including cell individual offsets and time to trigger parameters). These can all be modified to adjust load between cells. These parameters all exist in 5G as well as in 4G technologies. Commercial implementation of the DDE RL approach described herein may use CIO and related parameters.

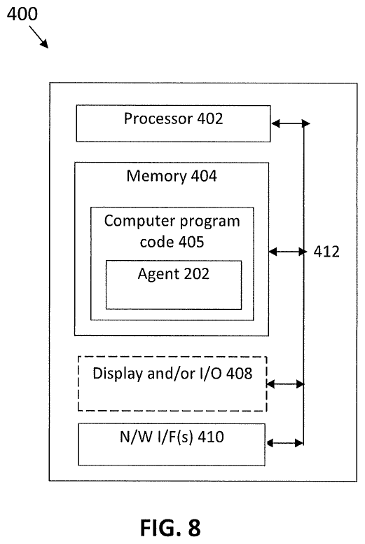

FIG. 8 is an example apparatus 400, which may be implemented in hardware, configured to implement the examples described herein. The apparatus 400 comprises a processor 402, at least one non-transitory or transitory memory 404 including computer program code 405, where the at least one memory 404 and the computer program code 405 are configured to, with the at least one processor 402, cause the apparatus to implement circuitry, a process, component, module, or function (collectively agent 202) to implement reinforcement learning for SON parameter optimization. The apparatus 400 optionally includes a display and/or I/O interface 408 that may be used to display aspects or a status of the methods described herein (e.g., as one of the methods is being performed or at a subsequent time). The apparatus 400 includes one or more network (N/W) interfaces (I/F(s)) 410. The N/W I/F(s) 410 may be wired and/or wireless and communicate over the Internet/other network(s) via any communication technique. The N/W I/F(s) 410 may comprise one or more transmitters and one or more receivers. The N/W I/F(s) 410 may comprise standard well-known components such as an amplifier, filter, frequency-converter, (de)modulator, and encoder/decoder circuitries and one or more antennas.

The apparatus 400 may be RAN node 170 or network element(s) 190 (e.g. to implement the functionality of the agent 202). Thus, processor 402 may correspond respectively to processor(s) 152 or processor(s) 175, memory 404 may correspond respectively to memory(ies) 155 or memory(ies) 171, computer program code 405 may correspond respectively to computer program code 153, module 150-1, module 150-2, or computer program code 173, and N/W I/F(s) 410 may correspond respectively to N/W I/F(s) 161 or N/W I/F(s) 180. Alternatively, apparatus 400 may not correspond to either of RAN node 170 or network element(s) 190, as apparatus 400 may be part of a self-organizing/optimizing network (SON) node, such as in a cloud. The apparatus 400 may also be distributed throughout the network 100 including within and between apparatus 400 and any one of the network element(s) (190) (such as a network control element (NCE)) and/or the RAN node 170.

Interface 412 enables data communication between the various items of apparatus 400, as shown in FIG. 8. Interface 412 may be one or more buses, or interface 412 may be one or more software interfaces configured to pass data between the items of apparatus 400. For example, the interface 412 may be one or more buses such as address, data, or control buses, and may include any interconnection mechanism, such as a series of lines on a motherboard or integrated circuit, fiber optics or other optical communication equipment, and the like. The apparatus 400 need not comprise each of the features mentioned, or may comprise other features as well.

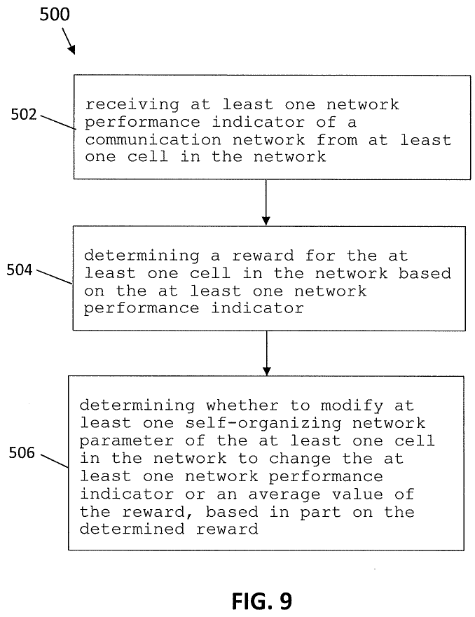

FIG. 9 is an example method 500 to implement reinforcement learning for SON parameter optimization, based on the example embodiments described herein. At 502, the method includes receiving at least one network performance indicator of a communication network from at least one cell in the network. At 504, the method includes determining a reward for the at least one cell in the network based on the at least one network performance indicator. At 506, the method includes determining whether to modify at least one self-organizing network parameter of the at least one cell in the network to change the at least one network performance indicator or an average value of the reward, based in part on the determined reward. Method 500 may be performed by apparatus 400, network element(s) 190, radio node 170, or any combination of those.

References to a ‘computer’, ‘processor’, etc. should be understood to encompass not only computers having different architectures such as single/multi-processor architectures and sequential or parallel architectures but also specialized circuits such as field-programmable gate arrays (FPGAs), application specific circuits (ASICs), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

The memory(ies) as described herein may be implemented using any suitable data storage technology, such as semiconductor based memory devices, flash memory, magnetic memory devices and systems, optical memory devices and systems, non-transitory memory, transitory memory, fixed memory and removable memory. The memory(ies) may comprise a database for storing data.

As used herein, the term ‘circuitry’ may refer to the following: (a) hardware circuit implementations, such as implementations in analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present. As a further example, as used herein, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

An example method includes receiving at least one network performance indicator of a communication network from at least one cell in the network; determining a reward for the at least one cell in the network based on the at least one network performance indicator; and determining whether to modify at least one self-organizing network parameter of the at least one cell in the network to change the at least one network performance indicator or an average value of the reward, based in part on the determined reward.

Other aspects of the method may include the following. The at least one self-organizing network parameter may be related to at least one of: an antenna tilt of at least one antenna in the network; an electrical antenna tilt of the at least one antenna in the network; a parameter related to a multiple input multiple output antenna; a mobility parameter; a cell individual offset; or a time to trigger. The at least one antenna may be at least one antenna of a base station in the network. The method may further include normalizing the at least one network performance indicator prior to determining the reward using a cumulative distribution function with a sample mean and sample standard deviation of at least one measurement recorded in a simulation round with the at least one self-organizing network parameter of the at least one cell in the network set to a static value. The method may further include determining a current physical resource block utilization based on the received at least one network performance indicator; determining an optimal physical resource block utilization based on the reward; determining a difference between the current physical resource block utilization and the optimal physical resource block utilization; and decreasing the at least one self-organizing network parameter in response to the current physical resource block utilization being less than the optimal physical resource block utilization, or increasing the at least one self-organizing network parameter in response to the current physical resource block utilization being greater than the optimal physical resource block utilization. The at least one self-organizing network parameter may be a tilt of at least one antenna in the network. The optimal physical resource block utilization may be determined through estimating the reward for a plurality of discrete quantized levels of physical resource block utilization for the at least one cell. The method may further include determining a state of the network using at least one selected one of the at least one network performance indicator. Determining the state may comprise determining a normalized number of active users connected to the at least one cell; determining a normalized throughput per user and a normalized thresholded physical resource block utilization; or determining a normalized throughput per user and a normalized physical resource block utilization. The method may further include determining, with probability epsilon, a value for the at least one self-organizing parameter that maximizes the reward for the at least one cell among a set of possible values for the self-organizing parameter, based on the state of the network; and determining, with probability one minus epsilon, the value for the at least one self-organizing parameter based on comparing a current physical resource block utilization to an optimal physical resource block utilization, the current physical resource block utilization being based on the received at least one network performance indicator, and the optimal physical resource block utilization being determined through estimating the reward for a plurality of discrete quantized levels of physical resource block utilization for the at least one cell. The at least one self-organizing network parameter may be a tilt of at least one antenna in the network, and the set of possible values may be a set of possible antenna tilts. The method may further include determining, with probability epsilon, a value for the at least one self-organizing parameter that maximizes a predicted reward for the at least one cell among a set of possible values for the self-organizing parameter based on the state of the network, the predicted reward determined using a neural network trained with gradient descent; and determining, with probability one minus epsilon, the value for the at least one self-organizing parameter based on comparing a current physical resource block utilization to an optimal physical resource block utilization, the current physical resource block utilization being based on the received at least one network performance indicator, and the optimal physical resource block utilization being determined through estimating the reward for a plurality of discrete quantized levels of physical resource block utilization for the at least one cell. The at least one self-organizing network parameter may be a tilt of at least one antenna in the network, and the set of possible values may be a set of possible antenna tilts. The method may further include training the neural network using a target vector corresponding to an action taken by the at least one cell, the target vector having been overwritten with the determined reward. The reward may be calculated as a weighted average of the reward determined for the at least one cell and at least one other reward determined for at least one cell neighboring the at least one cell. The reward may be determined with at least one initialized value. The method may further include generating a simulator of the network that approximates the at least one self-organizing network parameter of the network; and connecting the simulator off-line within a closed loop with a reinforcement learning agent to converge the reinforcement learning agent to the at least one initialized value. The method may further include increasing a tilt of at least one antenna in the network when a physical resource block utilization should be decreased, and decreasing the tilt of the at least one antenna in the network when the physical resource block utilization should be increased. The method may further include maintaining a physical resource utilization reward table for the at least one cell, the physical resource utilization reward table comprising a mapping of a plurality of physical resource block utilization levels within the at least one cell, to respective average rewards experienced for the at least one cell; and updating the physical resource utilization reward table based in part on the determined reward. The method may further include determining the reward using a maximum value from the physical resource utilization reward table. The method may further include maintaining an average reward table for the at least one cell, the average reward table comprising a mapping of a plurality of states of the at least one cell and plurality of possible modifications to the at least one self-organizing network parameter for the at least one cell, to respective average rewards experienced for the at least one cell; and updating the average reward table based in part on the determined reward. The method may further include determining the reward using a maximum value from the average reward table. The average reward table may be a q-table. The method may be implemented within a self-organizing network node, an open radio access network node, or a radio access network node, the radio access network node being a base station. The determining of whether to modify the at least one self-organizing network parameter may be based on either domain directed exploration, reinforcement learning with domain directed exploration, or deep reinforcement learning with domain directed exploration. The determining of whether to modify the at least one self-organizing network parameter within the at least one cell in the network may be performed for a plurality of cells within the network, and the reward may be calculated respectively for the plurality of cells within the network. The at least one network performance indicator of the network may be received during a time interval, and the reward is determined based at least on averaging the at least one network performance indicator over the time interval. The at least one self-organizing network parameter may be modified to adjust a load between the at least one cell and at least one other cell in the network. The reward may be determined using at least one thresholded network performance indicator, the at least one thresholded network performance indicator being configured to provide a greater reward to at least one state when the at least one network performance indicator belongs to a defined range, the defined range being configurable. The at least one thresholded network performance indicator may be thresholded physical resource block utilization, and the at least one network performance indicator may be physical resource block utilization. The reward may be determined as a weighted combination of the at least one network performance indicator, and another network performance indicator. The at least one network performance indicator may be a download throughput of the network, and the another network performance indicator may be a physical resource block utilization of the network. The method may further include increasing epsilon following determining the value for the at least one self-organizing parameter that maximizes the reward for the at least one cell among a set of possible values for the self-organizing parameter. The method may further include increasing epsilon following determining the value for the at least one self-organizing parameter that maximizes the predicted reward for the at least one cell among a set of possible values for the self-organizing parameter. The determining of whether to modify the at least one self-organizing network parameter within the at least one cell in the network may be performed using reinforcement learning or q-learning.

An example apparatus includes at least one processor; and at least one non-transitory memory including computer program code; wherein the at least one memory and the computer program code are configured to, with the at least one processor, cause the apparatus at least to: receive at least one network performance indicator of a communication network from at least one cell in the network; determine a reward for the at least one cell in the network based on the at least one network performance indicator; and determine whether to modify at least one self-organizing network parameter of the at least one cell in the network to change the at least one network performance indicator or an average value of the reward, based in part on the determined reward.

Other aspects of the apparatus may include the following. The at least one self-organizing network parameter may be related to at least one of: an antenna tilt of at least one antenna in the network; an electrical antenna tilt of the at least one antenna in the network; a parameter related to a multiple input multiple output antenna; a mobility parameter; a cell individual offset; or a time to trigger. The at least one antenna may be at least one antenna of a base station in the network. The at least one memory and the computer program code may be further configured to, with the at least one processor, cause the apparatus at least to: normalize the at least one network performance indicator prior to determining the reward using a cumulative distribution function with a sample mean and sample standard deviation of at least one measurement recorded in a simulation round with the at least one self-organizing network parameter of the at least one cell in the network set to a static value. The at least one memory and the computer program code may be further configured to, with the at least one processor, cause the apparatus at least to: determine a current physical resource block utilization based on the received at least one network performance indicator; determine an optimal physical resource block utilization based on the reward; determine a difference between the current physical resource block utilization and the optimal physical resource block utilization; and decrease the at least one self-organizing network parameter in response to the current physical resource block utilization being less than the optimal physical resource block utilization, or increase the at least one self-organizing network parameter in response to the current physical resource block utilization being greater than the optimal physical resource block utilization. The at least one self-organizing network parameter may be a tilt of at least one antenna in the network. The optimal physical resource block utilization may be determined through estimating the reward for a plurality of discrete quantized levels of physical resource block utilization for the at least one cell. The at least one memory and the computer program code may be further configured to, with the at least one processor, cause the apparatus at least to: determine a state of the network using at least one selected one of the at least one network performance indicator. Determining the state may comprise determining a normalized number of active users connected to the at least one cell; determining a normalized throughput per user and a normalized thresholded physical resource block utilization; or determining a normalized throughput per user and a normalized physical resource block utilization. The at least one memory and the computer program code may be further configured to, with the at least one processor, cause the apparatus at least to: determine, with probability epsilon, a value for the at least one self-organizing parameter that maximizes the reward for the at least one cell among a set of possible values for the self-organizing parameter, based on the state of the network; and determine, with probability one minus epsilon, the value for the at least one self-organizing parameter based on comparing a current physical resource block utilization to an optimal physical resource block utilization, the current physical resource block utilization being based on the received at least one network performance indicator, and the optimal physical resource block utilization being determined through estimating the reward for a plurality of discrete quantized levels of physical resource block utilization for the at least one cell. The at least one self-organizing network parameter may be a tilt of at least one antenna in the network, and the set of possible values may be a set of possible antenna tilts. The at least one memory and the computer program code may be further configured to, with the at least one processor, cause the apparatus at least to: determine, with probability epsilon, a value for the at least one self-organizing parameter that maximizes a predicted reward for the at least one cell among a set of possible values for the self-organizing parameter based on the state of the network, the predicted reward determined using a neural network trained with gradient descent; and determine, with probability one minus epsilon, the value for the at least one self-organizing parameter based on comparing a current physical resource block utilization to an optimal physical resource block utilization, the current physical resource block utilization being based on the received at least one network performance indicator, and the optimal physical resource block utilization being determined through estimating the reward for a plurality of discrete quantized levels of physical resource block utilization for the at least one cell. The at least one self-organizing network parameter may be a tilt of at least one antenna in the network, and the set of possible values may be a set of possible antenna tilts. The at least one memory and the computer program code may be further configured to, with the at least one processor, cause the apparatus at least to: train the neural network using a target vector corresponding to an action taken by the at least one cell, the target vector having been overwritten with the determined reward. The reward may be calculated as a weighted average of the reward determined for the at least one cell and at least one other reward determined for at least one cell neighboring the at least one cell. The reward may be determined with at least one initialized value. The at least one memory and the computer program code may be further configured to, with the at least one processor, cause the apparatus at least to: generate a simulator of the network that approximates the at least one self-organizing network parameter of the network; and connect the simulator off-line within a closed loop with a reinforcement learning agent to converge the reinforcement learning agent to the at least one initialized value. The at least one memory and the computer program code may be further configured to, with the at least one processor, cause the apparatus at least to: increase a tilt of at least one antenna in the network when a physical resource block utilization should be decreased, and decrease the tilt of the at least one antenna in the network when the physical resource block utilization should be increased. The at least one memory and the computer program code may be further configured to, with the at least one processor, cause the apparatus at least to: maintain a physical resource utilization reward table for the at least one cell, the physical resource utilization reward table comprising a mapping of a plurality of physical resource block utilization levels within the at least one cell, to respective average rewards experienced for the at least one cell; and update the physical resource utilization reward table based in part on the determined reward. The at least one memory and the computer program code may be further configured to, with the at least one processor, cause the apparatus at least to: determine the reward using a maximum value from the physical resource utilization reward table. The at least one memory and the computer program code may be further configured to, with the at least one processor, cause the apparatus at least to: maintain an average reward table for the at least one cell, the average reward table comprising a mapping of a plurality of states of the at least one cell and plurality of possible modifications to the at least one self-organizing network parameter for the at least one cell, to respective average rewards experienced for the at least one cell; and update the average reward table based in part on the determined reward. The at least one memory and the computer program code may be further configured to, with the at least one processor, cause the apparatus at least to: determine the reward using a maximum value from the average reward table. The average reward table may be a q-table. The apparatus may be implemented within a self-organizing network node, an open radio access network node, or a radio access network node, the radio access network node being a base station. The determining of whether to modify the at least one self-organizing network parameter may be based on either domain directed exploration, reinforcement learning with domain directed exploration, or deep reinforcement learning with domain directed exploration. The determining of whether to modify the at least one self-organizing network parameter within the at least one cell in the network may be performed for a plurality of cells within the network, and the reward may be calculated respectively for the plurality of cells within the network. The at least one network performance indicator of the network may be received during a time interval, and the reward may be determined based at least on averaging the at least one network performance indicator over the time interval. The at least one self-organizing network parameter may be modified to adjust a load between the at least one cell and at least one other cell in the network. The reward may be determined using at least one thresholded network performance indicator, the at least one thresholded network performance indicator being configured to provide a greater reward to at least one state when the at least one network performance indicator belongs to a defined range, the defined range being configurable. The at least one thresholded network performance indicator may be thresholded physical resource block utilization, and the at least one network performance indicator may be physical resource block utilization. The reward may be determined as a weighted combination of the at least one network performance indicator, and another network performance indicator. The at least one network performance indicator may be a download throughput of the network, and the another network performance indicator may be a physical resource block utilization of the network. The at least one memory and the computer program code may be further configured to, with the at least one processor, cause the apparatus at least to: increase epsilon following determining the value for the at least one self-organizing parameter that maximizes the reward for the at least one cell among a set of possible values for the self-organizing parameter. The at least one memory and the computer program code may be further configured to, with the at least one processor, cause the apparatus at least to: increase epsilon following determining the value for the at least one self-organizing parameter that maximizes the predicted reward for the at least one cell among a set of possible values for the self-organizing parameter. The determining of whether to modify the at least one self-organizing network parameter within the at least one cell in the network may be performed using reinforcement learning or q-learning.

An example apparatus includes means for receiving at least one network performance indicator of a communication network from at least one cell in the network; means for determining a reward for the at least one cell in the network based on the at least one network performance indicator; and means for determining whether to modify at least one self-organizing network parameter of the at least one cell in the network to change the at least one network performance indicator or an average value of the reward, based in part on the determined reward.

Other aspects of the apparatus may include the following. The at least one self-organizing network parameter may be related to at least one of: an antenna tilt of at least one antenna in the network; an electrical antenna tilt of the at least one antenna in the network; a parameter related to a multiple input multiple output antenna; a mobility parameter; a cell individual offset; or a time to trigger. The at least one antenna may be at least one antenna of a base station in the network. The apparatus may further include means for normalizing the at least one network performance indicator prior to determining the reward using a cumulative distribution function with a sample mean and sample standard deviation of at least one measurement recorded in a simulation round with the at least one self-organizing network parameter of the at least one cell in the network set to a static value. The apparatus may further include means for determining a current physical resource block utilization based on the received at least one network performance indicator; means for determining an optimal physical resource block utilization based on the reward; means for determining a difference between the current physical resource block utilization and the optimal physical resource block utilization; and means for decreasing the at least one self-organizing network parameter in response to the current physical resource block utilization being less than the optimal physical resource block utilization, or increasing the at least one self-organizing network parameter in response to the current physical resource block utilization being greater than the optimal physical resource block utilization. The at least one self-organizing network parameter may be a tilt of at least one antenna in the network. The optimal physical resource block utilization may be determined through estimating the reward for a plurality of discrete quantized levels of physical resource block utilization for the at least one cell. The apparatus may further include means for determining a state of the network using at least one selected one of the at least one network performance indicator. Determining the state may comprise determining a normalized number of active users connected to the at least one cell; determining a normalized throughput per user and a normalized thresholded physical resource block utilization; or determining a normalized throughput per user and a normalized physical resource block utilization. The apparatus may further include means for determining, with probability epsilon, a value for the at least one self-organizing parameter that maximizes the reward for the at least one cell among a set of possible values for the self-organizing parameter, based on the state of the network; and means for determining, with probability one minus epsilon, the value for the at least one self-organizing parameter based on comparing a current physical resource block utilization to an optimal physical resource block utilization, the current physical resource block utilization being based on the received at least one network performance indicator, and the optimal physical resource block utilization being determined through estimating the reward for a plurality of discrete quantized levels of physical resource block utilization for the at least one cell. The at least one self-organizing network parameter may be a tilt of at least one antenna in the network, and the set of possible values may be a set of possible antenna tilts. The apparatus may further include means for determining, with probability epsilon, a value for the at least one self-organizing parameter that maximizes a predicted reward for the at least one cell among a set of possible values for the self-organizing parameter based on the state of the network, the predicted reward determined using a neural network trained with gradient descent; and means for determining, with probability one minus epsilon, the value for the at least one self-organizing parameter based on comparing a current physical resource block utilization to an optimal physical resource block utilization, the current physical resource block utilization being based on the received at least one network performance indicator, and the optimal physical resource block utilization being determined through estimating the reward for a plurality of discrete quantized levels of physical resource block utilization for the at least one cell. The at least one self-organizing network parameter may be a tilt of at least one antenna in the network, and the set of possible values may be a set of possible antenna tilts. The apparatus may further include means for training the neural network using a target vector corresponding to an action taken by the at least one cell, the target vector having been overwritten with the determined reward. The reward may be calculated as a weighted average of the reward determined for the at least one cell and at least one other reward determined for at least one cell neighboring the at least one cell. The reward may be determined with at least one initialized value. The apparatus may further include means for generating a simulator of the network that approximates the at least one self-organizing network parameter of the network; and means for connecting the simulator off-line within a closed loop with a reinforcement learning agent to converge the reinforcement learning agent to the at least one initialized value. The apparatus may further include means for increasing a tilt of at least one antenna in the network when a physical resource block utilization should be decreased, and means for decreasing the tilt of the at least one antenna in the network when the physical resource block utilization should be increased. The apparatus may further include means for maintaining a physical resource utilization reward table for the at least one cell, the physical resource utilization reward table comprising a mapping of a plurality of physical resource block utilization levels within the at least one cell, to respective average rewards experienced for the at least one cell; and means for updating the physical resource utilization reward table based in part on the determined reward. The apparatus may further include means for determining the reward using a maximum value from the physical resource utilization reward table. The apparatus may further include means for maintaining an average reward table for the at least one cell, the average reward table comprising a mapping of a plurality of states of the at least one cell and plurality of possible modifications to the at least one self-organizing network parameter for the at least one cell, to respective average rewards experienced for the at least one cell; and means for updating the average reward table based in part on the determined reward. The apparatus may further include means for determining the reward using a maximum value from the average reward table. The average reward table may be a q-table. The apparatus may be implemented within a self-organizing network node, an open radio access network node, or a radio access network node, the radio access network node being a base station. The determining of whether to modify the at least one self-organizing network parameter may be based on either domain directed exploration, reinforcement learning with domain directed exploration, or deep reinforcement learning with domain directed exploration. The determining of whether to modify the at least one self-organizing network parameter within the at least one cell in the network may be performed for a plurality of cells within the network, and the reward may be calculated respectively for the plurality of cells within the network. The at least one network performance indicator of the network may be received during a time interval, and the reward may be determined based at least on averaging the at least one network performance indicator over the time interval. The at least one self-organizing network parameter may be modified to adjust a load between the at least one cell and at least one other cell in the network. The reward may be determined using at least one thresholded network performance indicator, the at least one thresholded network performance indicator being configured to provide a greater reward to at least one state when the at least one network performance indicator belongs to a defined range, the defined range being configurable. The at least one thresholded network performance indicator may be thresholded physical resource block utilization, and the at least one network performance indicator may be physical resource block utilization. The reward may be determined as a weighted combination of the at least one network performance indicator, and another network performance indicator. The at least one network performance indicator may be a download throughput of the network, and the another network performance indicator may be a physical resource block utilization of the network. The apparatus may further include means for increasing epsilon following determining the value for the at least one self-organizing parameter that maximizes the reward for the at least one cell among a set of possible values for the self-organizing parameter. The apparatus may further include means for increasing epsilon following determining the value for the at least one self-organizing parameter that maximizes the predicted reward for the at least one cell among a set of possible values for the self-organizing parameter. The determining of whether to modify the at least one self-organizing network parameter within the at least one cell in the network may be performed using reinforcement learning or q-learning.

An example non-transitory program storage device readable by a machine, tangibly embodying a program of instructions executable by the machine for performing operations is provided, the operations comprising: receiving at least one network performance indicator of a communication network from at least one cell in the network; determining a reward for the at least one cell in the network based on the at least one network performance indicator; and determining whether to modify at least one self-organizing network parameter of the at least one cell in the network to change the at least one network performance indicator or an average value of the reward, based in part on the determined reward.

Other aspects of the non-transitory program storage device may include the following. The at least one self-organizing network parameter may be related to at least one of: an antenna tilt of at least one antenna in the network; an electrical antenna tilt of the at least one antenna in the network; a parameter related to a multiple input multiple output antenna; a mobility parameter; a cell individual offset; or a time to trigger. The at least one antenna may be at least one antenna of a base station in the network. The operations of the non-transitory program storage device may further include normalizing the at least one network performance indicator prior to determining the reward using a cumulative distribution function with a sample mean and sample standard deviation of at least one measurement recorded in a simulation round with the at least one self-organizing network parameter of the at least one cell in the network set to a static value. The operations of the non-transitory program storage device may further include determining a current physical resource block utilization based on the received at least one network performance indicator; determining an optimal physical resource block utilization based on the reward; determining a difference between the current physical resource block utilization and the optimal physical resource block utilization; and decreasing the at least one self-organizing network parameter in response to the current physical resource block utilization being less than the optimal physical resource block utilization, or increasing the at least one self-organizing network parameter in response to the current physical resource block utilization being greater than the optimal physical resource block utilization. The at least one self-organizing network parameter may be a tilt of at least one antenna in the network. The optimal physical resource block utilization may be determined through estimating the reward for a plurality of discrete quantized levels of physical resource block utilization for the at least one cell. The operations of the non-transitory program storage device may further include determining a state of the network using at least one selected one of the at least one network performance indicator. Determining the state may comprise determining a normalized number of active users connected to the at least one cell; determining a normalized throughput per user and a normalized thresholded physical resource block utilization; or determining a normalized throughput per user and a normalized physical resource block utilization. The operations of the non-transitory program storage device may further include determining, with probability epsilon, a value for the at least one self-organizing parameter that maximizes the reward for the at least one cell among a set of possible values for the self-organizing parameter, based on the state of the network; and determining, with probability one minus epsilon, the value for the at least one self-organizing parameter based on comparing a current physical resource block utilization to an optimal physical resource block utilization, the current physical resource block utilization being based on the received at least one network performance indicator, and the optimal physical resource block utilization being determined through estimating the reward for a plurality of discrete quantized levels of physical resource block utilization for the at least one cell. The at least one self-organizing network parameter may be a tilt of at least one antenna in the network, and the set of possible values may be a set of possible antenna tilts. The operations of the non-transitory program storage device may further include determining, with probability epsilon, a value for the at least one self-organizing parameter that maximizes a predicted reward for the at least one cell among a set of possible values for the self-organizing parameter based on the state of the network, the predicted reward determined using a neural network trained with gradient descent; and determining, with probability one minus epsilon, the value for the at least one self-organizing parameter based on comparing a current physical resource block utilization to an optimal physical resource block utilization, the current physical resource block utilization being based on the received at least one network performance indicator, and the optimal physical resource block utilization being determined through estimating the reward for a plurality of discrete quantized levels of physical resource block utilization for the at least one cell. The at least one self-organizing network parameter may be a tilt of at least one antenna in the network, and the set of possible values may be a set of possible antenna tilts. The operations of the non-transitory program storage device may further include training the neural network using a target vector corresponding to an action taken by the at least one cell, the target vector having been overwritten with the determined reward. The reward may be calculated as a weighted average of the reward determined for the at least one cell and at least one other reward determined for at least one cell neighboring the at least one cell. The reward may be determined with at least one initialized value. The operations of the non-transitory program storage device may further include generating a simulator of the network that approximates the at least one self-organizing network parameter of the network; and connecting the simulator off-line within a closed loop with a reinforcement learning agent to converge the reinforcement learning agent to the at least one initialized value. The operations of the non-transitory program storage device may further include increasing a tilt of at least one antenna in the network when a physical resource block utilization should be decreased, and decrease the tilt of the at least one antenna in the network when the physical resource block utilization should be increased. The operations of the non-transitory program storage device may further include maintaining a physical resource utilization reward table for the at least one cell, the physical resource utilization reward table comprising a mapping of a plurality of physical resource block utilization levels within the at least one cell, to respective average rewards experienced for the at least one cell; and updating the physical resource utilization reward table based in part on the determined reward. The operations of the non-transitory program storage device may further include determining the reward using a maximum value from the physical resource utilization reward table. The operations of the non-transitory program storage device may further include maintaining an average reward table for the at least one cell, the average reward table comprising a mapping of a plurality of states of the at least one cell and plurality of possible modifications to the at least one self-organizing network parameter for the at least one cell, to respective average rewards experienced for the at least one cell; and updating the average reward table based in part on the determined reward. The operations of the non-transitory program storage device may further include determining the reward using a maximum value from the average reward table. The average reward table may be a q-table. The non-transitory program storage device may be implemented within a self-organizing network node, an open radio access network node, or a radio access network node, the radio access network node being a base station. The determining of whether to modify the at least one self-organizing network parameter may be based on either domain directed exploration, reinforcement learning with domain directed exploration, or deep reinforcement learning with domain directed exploration. The determining of whether to modify the at least one self-organizing network parameter within the at least one cell in the network may be performed for a plurality of cells within the network, and the reward may be calculated respectively for the plurality of cells within the network. The at least one network performance indicator of the network may be received during a time interval, and the reward may be determined based at least on averaging the at least one network performance indicator over the time interval. The at least one self-organizing network parameter may be modified to adjust a load between the at least one cell and at least one other cell in the network. The reward may be determined using at least one thresholded network performance indicator, the at least one thresholded network performance indicator being configured to provide a greater reward to at least one state when the at least one network performance indicator belongs to a defined range, the defined range being configurable. The at least one thresholded network performance indicator may be thresholded physical resource block utilization, and the at least one network performance indicator may be physical resource block utilization. The reward may be determined as a weighted combination of the at least one network performance indicator, and another network performance indicator. The at least one network performance indicator may be a download throughput of the network, and the another network performance indicator may be a physical resource block utilization of the network. The operations of the non-transitory program storage device may further include increasing epsilon following determining the value for the at least one self-organizing parameter that maximizes the reward for the at least one cell among a set of possible values for the self-organizing parameter. The operations of the non-transitory program storage device may further include increasing epsilon following determining the value for the at least one self-organizing parameter that maximizes the predicted reward for the at least one cell among a set of possible values for the self-organizing parameter. The determining of whether to modify the at least one self-organizing network parameter within the at least one cell in the network may be performed using reinforcement learning or q-learning.

It should be understood that the foregoing description is only illustrative. Various alternatives and modifications may be devised by those skilled in the art. For example, features recited in the various dependent claims could be combined with each other in any suitable combination(s). In addition, features from different embodiments described above could be selectively combined into a new embodiment. Accordingly, this description is intended to embrace all such alternatives, modifications and variances which fall within the scope of the appended claims.

1-140. (canceled)

141. A method comprising:
receiving at least one network performance indicator of a communication network from at least one cell in the network;
determining a reward for the at least one cell in the network based on the at least one network performance indicator; and
determining whether to modify at least one self-organizing network parameter of the at least one cell in the network to change the at least one network performance indicator or an average value of the reward, based in part on the determined reward.

142. An apparatus comprising:
at least one processor; and
at least one non-transitory memory including computer program code;
wherein the at least one memory and the computer program code are configured to, with the at least one processor, cause the apparatus at least to:
receive at least one network performance indicator of a communication network from at least one cell in the network;
determine a reward for the at least one cell in the network based on the at least one network performance indicator; and
determine whether to modify at least one self-organizing network parameter of the at least one cell in the network to change the at least one network performance indicator or an average value of the reward, based in part on the determined reward.

143. The apparatus of claim 142, wherein the at least one self-organizing network parameter is related to at least one of:
an antenna tilt of at least one antenna in the network;
an electrical antenna tilt of the at least one antenna in the network;
a parameter related to a multiple input multiple output antenna;
a mobility parameter;
a cell individual offset; or
a time to trigger.

144. The apparatus of claim 143, wherein the at least one antenna is at least one antenna of a base station in the network.

145. The apparatus of claim 142, wherein the at least one memory and the computer program code are further configured to, with the at least one processor, cause the apparatus at least to:
normalize the at least one network performance indicator prior to determining the reward using a cumulative distribution function with a sample mean and sample standard deviation of at least one measurement recorded in a simulation round with the at least one self-organizing network parameter of the at least one cell in the network set to a static value.

146. The apparatus of claim 142, wherein the at least one memory and the computer program code are further configured to, with the at least one processor, cause the apparatus at least to:
determine a current physical resource block utilization based on the received at least one network performance indicator;
determine an optimal physical resource block utilization based on the reward;
determine a difference between the current physical resource block utilization and the optimal physical resource block utilization; and
decrease the at least one self-organizing network parameter in response to the current physical resource block utilization being less than the optimal physical resource block utilization, or increase the at least one self-organizing network parameter in response to the current physical resource block utilization being greater than the optimal physical resource block utilization.

147. The apparatus of claim 146, wherein the at least one self-organizing network parameter is a tilt of at least one antenna in the network.

148. The apparatus of any claim 146, wherein the optimal physical resource block utilization is determined through estimating the reward for a plurality of discrete quantized levels of physical resource block utilization for the at least one cell.

149. The apparatus of claim 142, wherein the at least one memory and the computer program code are further configured to, with the at least one processor, cause the apparatus at least to:
determine a state of the network using at least one selected one of the at least one network performance indicator.

150. The apparatus of claim 149, wherein determining the state comprises:
determining a normalized number of active users connected to the at least one cell;
determining a normalized throughput per user and a normalized thresholded physical resource block utilization; or
determining a normalized throughput per user and a normalized physical resource block utilization.

151. The apparatus of claim 149, wherein the at least one memory and the computer program code are further configured to, with the at least one processor, cause the apparatus at least to:
determine, with probability epsilon, a value for the at least one self-organizing parameter that maximizes the reward for the at least one cell among a set of possible values for the self-organizing parameter, based on the state of the network; and
determine, with probability one minus epsilon, the value for the at least one self-organizing parameter based on comparing a current physical resource block utilization to an optimal physical resource block utilization, the current physical resource block utilization being based on the received at least one network performance indicator, and the optimal physical resource block utilization being determined through estimating the reward for a plurality of discrete quantized levels of physical resource block utilization for the at least one cell.

152. The apparatus of claim 151, wherein the at least one self-organizing network parameter is a tilt of at least one antenna in the network, and the set of possible values is a set of possible antenna tilts.

153. The apparatus of claim 149, wherein the at least one memory and the computer program code are further configured to, with the at least one processor, cause the apparatus at least to:
determine, with probability epsilon, a value for the at least one self-organizing parameter that maximizes a predicted reward for the at least one cell among a set of possible values for the self-organizing parameter based on the state of the network, the predicted reward determined using a neural network trained with gradient descent; and
determine, with probability one minus epsilon, the value for the at least one self-organizing parameter based on comparing a current physical resource block utilization to an optimal physical resource block utilization, the current physical resource block utilization being based on the received at least one network performance indicator, and the optimal physical resource block utilization being determined through estimating the reward for a plurality of discrete quantized levels of physical resource block utilization for the at least one cell.

154. The apparatus of claim 153, wherein the at least one self-organizing network parameter is a tilt of at least one antenna in the network, and the set of possible values is a set of possible antenna tilts.

155. The apparatus of claim 153, wherein the at least one memory and the computer program code are further configured to, with the at least one processor, cause the apparatus at least to:
train the neural network using a target vector corresponding to an action taken by the at least one cell, the target vector having been overwritten with the determined reward.

156. The apparatus of claim 142, wherein the reward is calculated as a weighted average of the reward determined for the at least one cell and at least one other reward determined for at least one cell neighboring the at least one cell.

157. The apparatus of claim 142, wherein the reward is determined with at least one initialized value.

158. The apparatus of claim 157, wherein the at least one memory and the computer program code are further configured to, with the at least one processor, cause the apparatus at least to:
generate a simulator of the network that approximates the at least one self-organizing network parameter of the network; and
connect the simulator off-line within a closed loop with a reinforcement learning agent to converge the reinforcement learning agent to the at least one initialized value.

159. The apparatus of claim 142, wherein the at least one memory and the computer program code are further configured to, with the at least one processor, cause the apparatus at least to:
increase a tilt of at least one antenna in the network when a physical resource block utilization should be decreased, and decrease the tilt of the at least one antenna in the network when the physical resource block utilization should be increased.

160. A non-transitory program storage device readable by a machine, tangibly embodying a program of instructions executable by the machine for performing operations, the operations comprising:
receiving at least one network performance indicator of a communication network from at least one cell in the network;
determining a reward for the at least one cell in the network based on the at least one network performance indicator; and
determining whether to modify at least one self-organizing network parameter of the at least one cell in the network to change the at least one network performance indicator or an average value of the reward, based in part on the determined reward.
